(19) United States
(12) Patent Application Publication
(10) Pub. No.: US 2008/0067757 A1
(43) Pub. Date: Mar. 20, 2008

(54) Multicylinder Internal Combustion Engine With Increased Useful Life

(75) Inventors: Franz J. Quadflieg, Heinsberg (DE); Taner Gocmez, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 11/857,800

(22) Filed: Sep. 19, 2007

(30) Foreign Application Priority Data
Sep. 19, 2006 (DE) 10 2006 043 832.9

(51) Int. Cl. F02F 1/24; F02F 11/00

(52) U.S. Cl. 277/593; 73/46

(57) ABSTRACT

The present invention relates to a multicylinder internal combustion engine with a cylinder head and with a cylinder block, which are fixed to each other by screw connections, where, between tie cylinder head and the cylinder block, a cylinder head seal is arranged, where, between two cylinders, a separate stress-relieving groove in the cylinder head is associated with each cylinder. The invention can also be used with individual cylinder heads. Moreover, a method is proposed by which an optimized design of at least one cylinder head is possible.

### CROSS-REFERENCE TO RELATED APPLICATIONS

This application claims priority of German Application DE 10 2006 043 832.9 filed Sep. 19, 2006, which is incorporated herein by reference.

### FIELD OF THE INVENTION

The present invention relates to a multicylinder internal combustion engine with a cylinder head or several individual cylinder heads and a cylinder block, which are fixed to each other via screw connections.

### BACKGROUND OF THE INVENTION

Multicylinder internal combustion engines, or commercial vehicles such as trucks, are beset by problems of obtaining of a sufficient gas seal between the cylinder head and the cylinder block, and, on the other hand, problems pertaining to the ability to withstand the stresses that occur in the process. From DE 37 27 598 C2, it is therefore known to improve a gas seal by centering the cylinder head seal used with a groove in the cylinder head and in the cylinder block. In this way, one ensures that there is no offset between the cylinder head housing, the cylinder bushing and the crankcase as a result of the stresses that occur. Therefore, a positioning groove is also arranged opposite the cylinder head housing in a cylinder bushing band. By applying pressure forces during the assembly of the components with screws, one also ensures that the interplay between the grooves and the cylinder head seal results in a sufficient gas seal by squeezing. From DE 103 44 110 A1 it is apparent again that grooves are also used in the area of cylinder housing and cylinder head. The patent shows that to prevent thermal stresses in the material of the cylinder head, a stress-relieving groove is provided, which is arranged between two coolant spaces of the cylinder head in a bottom plate. As a result, the heat addition is to be compensated, where the heat addition occurs through two adjacent combustion spaces into a bottom plate, followed by its transfer to the coolant spaces. The stress-relieving groove is also intended to allow a slight shifting on the cylinder head seal or on the cylinder housing.

The problem of the present invention is to design a multicylinder internal combustion engine in such a way that it presents high service life, particularly at peak pressures above 200 bar in the cylinder space.

### SUMMARY OF THE INVENTION

This problem is solved with a multicylinder internal combustion engine with the characteristic of claim 1 as well as with a method for the determination of the optimized connection of the cylinder head and the cylinder block of a multicylinder internal combustion engine with the characteristics of claim 13. Other advantageous embodiments and variants are indicated in the relevant dependent claims.

A multicylinder internal combustion engine with a cylinder head, or several cylinder heads and a cylinder block, is proposed, which are fixed to each other by screw connections, where, between the cylinder head and the cylinder block, a cylinder head seal is arranged. Between two respective cylinders, a separate relief groove is respectively arranged in the cylinder head, where the cylinders are preferably respectively located inside the gas seal of the cylinder head seal with respect to the given cylinder. Here, it is assumed that it is known that for the system of a multicylinder internal combustion engine, particularly at pressures above 200 bar in the cylinder space, the entire system must be considered in the interaction with its given individual components, which are adapted to each other. While in the previous designs it has been sufficient to take into account specific component geometries, the present proposal differs from that approach in that, on the one hand, each individual cylinder space and influences originating from it such as pressure, temperature, material fatigue, etc., are taken into account. On the other hand, the whole system and tie effect for each individual cylinder in this whole system are taken into account. The result is that at least one separate stress-relieving groove is respectively associated in the cylinder head with each cylinder, where the groove in turn is covered by the cylinder head seal.

It is preferred for the cylinder head seal to be designed in such a way that it makes available for each cylinder a gas seal, for example, by means of one or more stoppers and/or reinforcement seams. A stress-relieving groove associated with a cylinder then is arranged within a diameter determined by the gas seal in the cylinder head. In this way, it is possible to associate particularly with each cylinder within the gas seal in the cylinder head one or more stress-relieving grooves. As a result, one ensures that an improved thermomechanical strength is provided at high pressures for each cylinder area and associated cylinder head area. The overall effect of the association of the multicylinder internal combustion engine with cylinder head and cylinder block is an improved useful life, in spite of the high screw forces, because of the resulting improved stress-relief for the individual cylinder, particularly in the sensitive ranges of high pressures and temperatures, which improved stress-relief is with respect to mechanical forces in the material with simultaneously improved heat addition and heat flow due to the effect of the stress-relieving groove in the material of the cylinder head. In this interaction, the cylinder head seal, as an adapted component, is of particular importance.

If the cylinder head seal is used, it is preferred to use a metal cylinder head seal that presents several metal layers. In particular, several steel plates are connected to each other, which can present reinforcement seams or metal plate enclosures to increase the local compression. In addition, elastomer coatings can also be provided. The metal cylinder head seal can present one or more stoppers, which are capable of influencing the sealing slit oscillations as desired. The stopper can here be shaped in the form of a height profile in one or more of the layers of the cylinder head seal. The stoppers preferably have a height of 0.1 mm-0.15 mm. In addition, there is a possibility to provide a so-called plastic stopper. In a plastic stopper, its height profile is achieved by a plastic adaptation during the screw attachment of the cylinder head and the cylinder block. Besides a simple stopper, it is also possible to use a double stopper. Here, a stopper can be formed along an internal combustion space periphery by a folded flanging, where a second stopper is implemented behind a reinforcement seam by having two layers overlap. Using, for example, a laser welded seam, the two stopper layers can be connected to each other in the overlapping area. In addition, there is the possibility of a double stopper, which, however, can be prepared in a different way. In the case of two stoppers, which are used as a gas seal for a cylinder, it is preferred to use different material thicknesses. In this way, a compression distribution can be adjusted. It is preferred to use this if a cylinder bushing is used.

The stopper in a cylinder head seal can present a great variety of different geometries. For example, the stopper can present a trapezoid shape or it can also be formed as a simple flat surface. The cylinder head seal can also present reinforcement seams or steel rings, additionally or as an alternative.

However, cylinder head seals that present no stopper can also be used. For example, metal-soft material cylinder head seals can also be used. Here, a metal support plate, for example, is provided in each case on both sides with a soft substance layer and a plastic coating. As a result of the peripheral crimping, a gas sealing effect can be achieved in this way.

The selection of the cylinder head seal can also depend on whether the cylinder head and/or the cylinder block are constructed from a light metal. If the forces and the heat distribution are designed appropriately, it may be advantageous, for example, to be able to omit a stopper in the context of tie cylinder head seal. As light metal, an aluminum alloy can be provided, for example. There is also the possibility of using a magnesium alloy, as well as components that provide a combination structure with aluminum and magnesium. A number of layers used in the cylinder head seal, reinforcement seams and stopper, as well as any coatings are thus optimized in the interaction with the design of the stress-relieving groove.

The stress-relieving groove that is assigned to each cylinder can present different designs. One design provides for the arrangement inside the diameter determined by the gas seal of at least two stress-relieving grooves that run approximately parallel to each other. It is preferred here that the approximately parallel running stress-relieving grooves be arranged in a cross direction with respect to the crankshaft axis. Here, the two stress-relieving grooves can be arranged in each case opposite each other, separated by the cylinder bore within the diameter determined by the gas seal in tie cylinder head.

In an additional embodiment, for example, at least one stress-relieving groove runs on a circular path around the associated cylinder. It is also possible for at least one stress-relieving groove to present an interrupted course. Here, the possibility exists particularly of a circular shape in the case of the virtual continuation of the given ends of the stress-relieving grooves. In an additional embodiment, the bottom of one stress-relieving groove presents different heights and depths. As a result, on the one hand, it is possible to take into account the given material existing in the cylinder head, particularly the geometry with respect to the arrangement and the course of tie cooling. On the other hand, it is possible to design the bottom of the stress-relieving groove with different depths or with a rising or down sloping profile, allowing the generation of compensation stresses as a result of targeted notch actions around the cylinder in the cylinder head.

In a variant, one stress-relieving groove in the cylinder head remains at least itself substantially free of the cylinder head seal when the cylinder head and the cylinder block are connected to each other by the screw connection. Tis makes it possible, for example, for a separation to occur between a fixation of the cylinder head seal, for example, in the cylinder block, and the seal proper to ensure the sealing properties by means of the gas seal. For example, the cylinder head seal can cover or at least partially cover the stress-relieving grooves with an at least approximately planar area. As a result a partial sealing of the groove or grooves can be achieved, although the gas seal proper encloses the groove outside. The groove or the grooves then should be included only partially in the internal combustion space volume, and thus influence the sealing to a slight degree.

Moreover, as a result of the targeted arrangement of the stress-relieving grooves in the cylinder head with respect to the given cylinders in the gas sealing area of the cylinder head seal, a release of an expansion concentration in a valve stem is made possible. For example, if a peripheral stress-relieving groove in the cylinder head is provided in its flame cover side, the possibility exists of providing a direction independent release of the expansion concentration. By means of mutually adapted, partially peripheral stress-relieving grooves, the expansion concentrations can be released partially, while in other directions they are maintained intentionally. Furthermore, it is possible, for example, by means of approximately straight running stress-relieving grooves, to achieve a release of an expansion concentration in only one direction.

According to another idea of the invention, a method is proposed for the determination of an optimized connection between the cylinder head and the cylinder block of a multicylinder internal combustion engine. The cylinder head and the cylinder block have to be screwed to each other. The method presents the following steps:

entry of an FEM-capable representation of a start configuration with regard to at least the cylinder block, the cylinder head, and their screw connection,

entry of an FEM-capable representation of a start configuration with respect to a cylinder head seal, taking into account at least a gas seal, which in each case is or are arranged distributed around at least a first and a second adjacent cylinder bore,

entry of a start configuration of at least, in each case, a stress-relieving groove associated with one of the first and second cylinder bores, where the start configuration takes into account a position of the stress-relieving groove between the gas seal and the associated cylinder bore, and

calculation of a thermomechanical fatigue behavior of at least the cylinder head with optimization of at least one geometry parameter concerning the stress-relieving grooves with a view to the thermomechanical fatigue behavior.

It is preferred for the method to provide an optimization of the arrangement of the stress-relieving grooves, where the latter are assigned particularly within a gas seal of a cylinder head seal, in each case to a cylinder. Besides an optimization of the arrangement and also of the geometry, an optimization preferably of the number of the stress-relieving grooves is also undertaken. In addition, the method can provide for making available, from a stored data library, a multitude of different cylinder head seal parameters, and for an automatic selection and associated modification among the different cylinder head seals until an optimized solution is found in the interaction with the fatigue behavior and the arrangement and geometry of the stress-relieving grooves.

The method is capable particularly of making available optimized selections with regard to the selection of the stress-relieving grooves for each individual cylinder. Because, as start configuration, the geometries of all the bodies are given, stress calculations can be carried out dynamically taking into account the influence of cooling, vibrations and thermal influences including via the cylinders, whose structures can be taken into account, as well as pertaining to consideration of the valve stem. Because of this combined approach, one considers not only a section of the cylinder head alone, but rather the whole system as well, to be able to derive therefrom, by derivation, an optimized solution with regard to the arrangement and the design of the stress-relieving grooves for each individual cylinder, which solution is adapted to the whole concept.

In addition, it is possible, for example, to incorporate an aging process of the materials as well as the dynamic calculations. In this way one can ensure that the interconnected components of the multicylinder internal combustion engine also present a corresponding long-term useful life. Preferably, in the method with respect to determining one solution according to tie invention, a verification of the service life is subsequently carried out, on the basis of a thermomechanical calculation. If said strength is below a possibly predetermined value, a new calculation can be carried out with changed parameters.

In the method, it is preferred for several of the stoppers or reinforcement seams to be given a distributed association at least in each case with the first and second cylinder arrangement, to establish a gas seal. These are taken into account in the context of the optimization and are optimized, for example, with regard to the arrangement, its construction, properties and also geometries.

### BRIEF DESCRIPTION OF THE DRAWINGS

Other advantageous embodiments and variants are represented in the figures below. The embodiments that are apparent in the figures, however, are only nonlimiting examples. The characteristics indicated in them can be connected to each other, in each case, as well as to characteristics that have been described above, to obtain additional embodiments that are not described in further detail. Shown are:

FIG. 1: a schematic view of a cross-section of a multicylinder internal combustion engine, in which, in the cylinder head, a separate stress-relieving groove for each cylinder is arranged,

FIG. 2: a schematic overview representation of a possible first embodiment of the stress-relieving groove,

FIG. 3: a possible second variant of an embodiment of the stress-relieving groove,

FIG. 4: a calculation of the useful life with reference to different arrangements of the stress-relieving groove in the cylinder head,

FIG. 5: a schematic overview with regard to the useful life taking into account different aspects with regard to the stress-relieving groove, plotted in each case on the x axis and separate from each other,

FIG. 6: a schematic view of a possible embodiment of the proposed method, and

FIG. 7: a schematic view of a cylinder head from below with arrangements of different stress-relieving grooves.

### DETAILED DESCRIPTION OF THE PREFERRED EMBODIMENTS

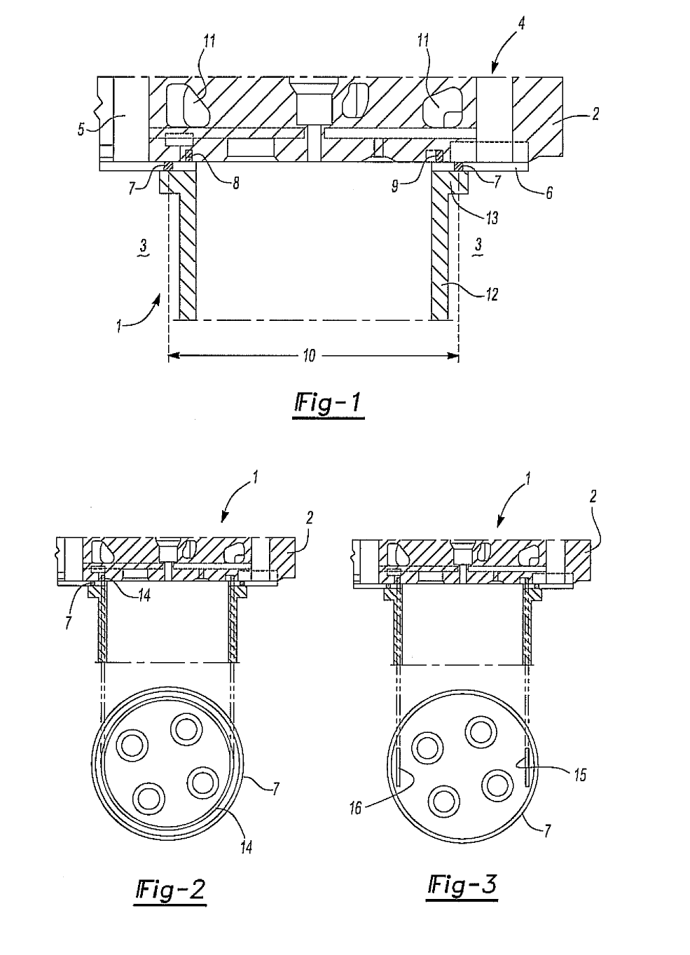

FIG. 1 shows a cross-section of a multicylinder internal combustion engine 1. The representation is a schematic view of a cylinder head 2, which is connected to a cylinder block 3—not shown in greater detail—via a screw connection 4. With regard to the screw connection 4, bores 5 in the cylinder head 2 are represented, through which the cylinder head—not shown in further detail—can be screwed into the cylinder block. Between the cylinder block 3 and the cylinder head 2, moreover, a cylinder head seal 6 is arranged. The cylinder head seal is provided, for each cylinder, with a gas seal 7. The cylinder head according to this example presents a first stress-relieving groove 8 and a second stress-relieving groove 9, with respect to a diameter 10, which can be determined from the gas seal 7, which runs around the cylinder space proper. The stress-relieving grooves 8, 9 are arranged inside the diameter 10. It is preferred for the latter to be also covered by the cylinder head seal 6, in each case. In the represented variant, for example, the stress-relieving grooves 8, 9 are arranged in an area of cooling perforations in the cylinder head, which run over the stress-relieving grooves 8, 9. An additional embodiment, which is also integrated in tie schematic view, shows a cylinder bushing 12 with a flange 13 arranged around the cylinder bushing 12. The stress-relieving grooves 8, 9 are covered in the process, on the one hand, within the diameter 10 and, on the other hand, over the flange 13 with tie cylinder head seal 6. Because a pressure transfer and resulting tensions during the screwing of the cylinder head 2 and the cylinder block 3 to each other, particularly in the case of different material pairings, causes different stress progressions, it was discovered on the basis of the thermal loading that the arrangement represented in FIG. 1 is particularly advantageous for commercial vehicle motors and, in particular, for other truck motors.

FIG. 2 shows, in a schematic representation, on the one hand, the cross-section from FIG. 1 and, on the other hand, a first embodiment of the course of a third stress-relieving groove 14. The third stress-relieving groove 14 runs within the diameter that is determined by the gas seal 7. Below the cross-section from FIG. 1, a top view is represented as an example. The gas seal 7 as well as the third stress-relieving groove 14 and its given position are here marked by line-dot drawn arrows. The inlet and outlet valves in the cylinder head are represented only in a cursory schematic manner. The third stress-relieving groove 14 is circular and continuous, particularly with constant width and constant depth. However, the possibility also exists to vary the width as well as the depth, particularly as a function of the occurrence of stresses in the cylinder head itself.

FIG. 3 shows an additional exemplary embodiment starting from the cross-section of FIG. 1 with regard to the multicylinder internal combustion engine 1. Here, a fourth stress-relieving groove 15 and a fifth stress-relieving groove 16 are arranged inside the gas seal 7 in the cylinder head 2. The two stress-relieving grooves 15, 16 run parallel to each other and they are arranged particularly in a direction transverse to a crankshaft—not represented in further detail—of the multicylinder internal combustion engine 1. The stress-relieving grooves 15, 16 preferably have the same dimensions. However, they also can present different dimensions, particularly as a result of the given location of the cylinder, which is not represented in further detail. For example, the width as well as the depth of the fourth and of the fifth stress-relieving grooves 15, 16 may differ from each other.

FIG. 4 shows an example of an examination of a depth of a stress-relieving groove in the cylinder head. For this purpose, the depth of the stress-relieving groove is indicated on the x axis in a normalized manner. The determined useful life is indicated on the y axis. In the schematically indicated cylinder head area, besides the valves, regions are also indicated which present, in each case viewed for themselves, critical stresses. As a result of the design of the groove with respect to its depth, one can achieve the result that the stresses in the individual regions overall are degraded in such a way that, in the evaluation of the useful life, an adaptation occurs over all the regions. In the represented example, the useful lives for the region 4 and the region 7 are indicated. The result is a particularly good useful life, provided the depth of the groove is within a special range. As one can see in the representation, it is preferred for this range to be 0.5-0.75 of the normalized depth. The normalized depth here is given with respect to a maximum depth, which is examined in the context of an optimization method. In the example represented here, 6 mm was used as the maximum depth. However, it is also possible to use larger or smaller values as maximum depth. For example, an optimized range as a function of different additional parameters can be, for example, a depth of 15-3 mm.

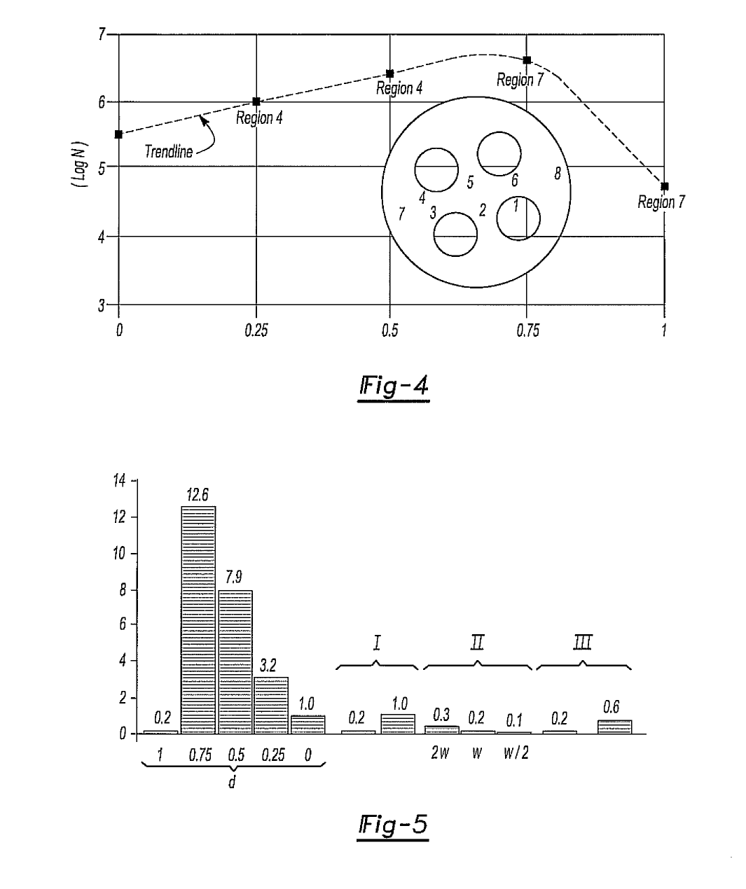

FIG. 5 shows, with regard to an optimization, an example of an embodiment with advantageous effect on the useful life. The useful life is plotted as useful life factor on the y axis. On the x axis, the first five columns are tie values determined for the factor at different depths, which were determined in a thermomechanical strength examination, a so-called TMF analysis. The next two columns, called I, show the effect of the special arrangement of a stress-relieving groove in the cylinder head. Next is the influence of a width w on the useful life factor. The three associated columns are combined under II. The next two columns show the influence of the geometry of the stress-relieving groove on the useful life factor. These two columns are combined under III. As can be seen in the different values at different depths d, it is particularly advantageous if the depths are kept within a certain range. In the case represented here, a depth range of 0.75-0.5 of the normalized depth is used. It has been found that the useful life factors decrease very rapidly outside that range, so that a lowered operational strength is expected.

Columns I to III in FIG. 5 were determined at a constant depth d. The columns under I indicate the result of a positioning of a stress-relieving groove at an originally critical spot: a shifting of the critical spot into another position. While it was initially in the groove, which is indicated on the left with the small column, it shifted into another position. The goal here was to shift the critical spot out of the stress-relieving groove even in a valve bridge area. The result was that the useful life factor could be increased successfully five fold. In the process, the stress-relieving groove is arranged with the gas seal. The area II shows the influence of the width w. Here one can see that an increased useful life factor can be achieved with a greater width, However, one can observe that the factor drops very strongly if a maximum width is exceeded. The area III shows the influence of the geometry of the stress-relieving groove on the factor. Here it was found that, by avoiding sharp edges inside the stress-relieving groove, the corresponding factor could be raised strongly.

The examination of the thermomechanical strength as shown in FIG. 5, is determined, for example, according to the above-described method, by first conducting an optimization of a groove depth, before an optimization of a groove width. If the groove width and the groove depth are fixed, then the groove geometry can be improved further. The influence of the shift of the critical spot, due to the arrangement of the stress-relieving groove within the diameter determined by the gas seal, can also be taken into account here.

It has been found to be advantageous to use, as reference magnitude for a depth of the stress-relieving groove, a flame cover thickness. It is preferred for the depth to present a value of 15-30% of a flame cover thickness. As flame cover thickness one can use, for example, the separation between the external flame cover, which abuts the cylinder space, and an abutment of the flame cover thickness arranged in the cylinder head by means of a cooling jacket that runs there in the area of the groove. As the width of a stress-relieving groove, it is preferred to choose a range of 2-3% of a bore diameter of the given associated cylinder.

As additional examinations have shown, the service life of the cylinder head is not affected in spite of associating a stress-relieving groove with each cylinder. In this regard, calculations have shown that safety against fatigue fracture at different depths and widths of the stress-relieving groove leads to an increase in the service life, particularly after an appropriate optimization.

Therefore, the method advantageously provides that, in a first optimization procedure, the effect with regard to the thermomechanical strength is determined, before a service life occurs by means of an HCF examination. As a result, one can ensure that component geometries, in spite of the fact that they have been optimized from the stress point of view, nevertheless can be used in fact also as aspects relating to service life.

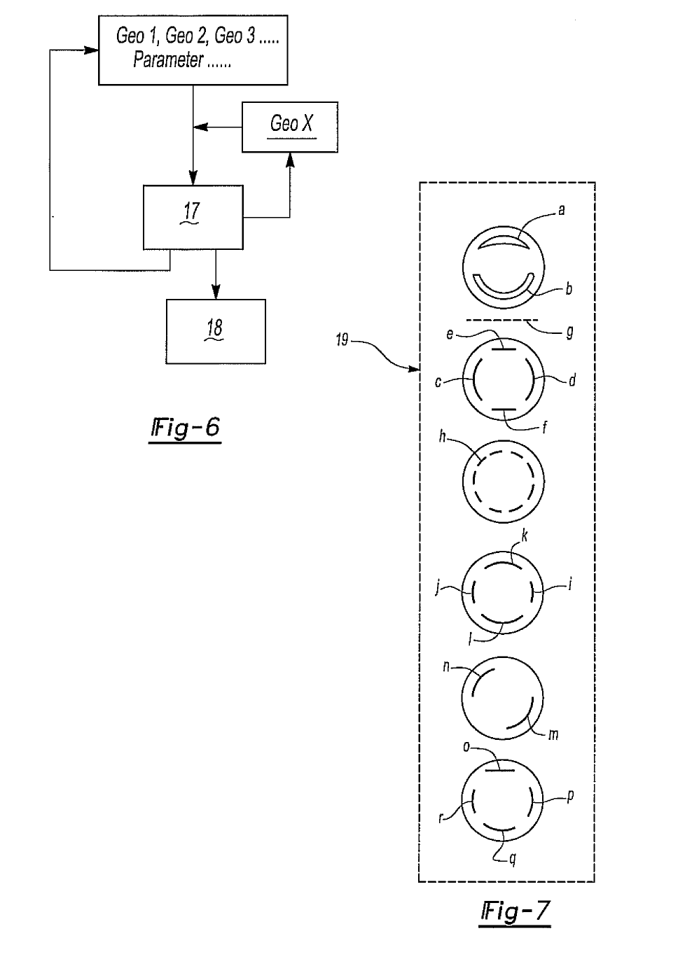

FIG. 6 shows an extremely simplified representation of an exemplary course of a possible embodiment of the claimed method. For example, in a first step, different geometries are given as starting configuration. For example, there may be a geometry Geo 1 for the cylinder, a geometry Geo 2 for the cylinder block, and a geometry Geo 3 for the screw connection. Other additional start parameters, as well as boundary parameters, can also be entered. Particularly, for example, this can concern the geometry and also arrangement of one or more grooves. Moreover, the possibility exists of being able to predetermine either only one cylinder, or several, particularly all the cylinders, as well as in each case the associated stress-relieving grooves in the cylinder head by means of a start geometry. Then, for example, using a library, a start geometry can be read, with respect to a cylinder head seal Geo X. In an optimization block 17, one or more geometries can then be optimized. In the process, it is advantageous to carry out parallel computations with regard to the stress-relieving grooves, which are each associated with a cylinder, to be able to measure the influence of the stress-relieving grooves among each other on the overall geometry of the cylinder head and of the cylinder block. In the process, heat flow under different operating conditions is taken particularly into account. As a result one can ensure, for example, that a single operational point is not used alone during the optimization, rather the optimization also takes account of different requirements placed on the multicylinder internal combustion engine. The optimizations produce, on the one hand, new start parameters or start geometries, which are used in an additional optimization calculation. Moreover, they can also be used optionally to be able to carry out, with a different geometry set, calculations regarding, for example, the cylinder head seal. For this purpose, for example, different types of cylinder head seals are stored in tie library. Instead of, or in addition to, the cylinder head seal, other parameters and geometries can, however, also be changed in the context of the optimization. At the end of the optimization method, a computer data bank 18 is established, which is preferably directly suited for manufacture. By means of this data bank, a casting-appropriate construction drawing can be prepared. Additional FEM calculations can also be carried out with the computer data bank 18.

FIG. 7 shows a schematic view of a 6-cylinder serial engine 19, whose cylinder head is represented in a simplified schematic drawing with the external contours in a broken line. As an exemplary view, the position of the gas seal is, on the one hand, represented as a closed full circle for each cylinder. On the other hand, different embodiments, as incomplete examples, show how the stress-relieving grooves could be implemented both with regard to their position and their shape.

The stress-relieving grooves present different courses, arrangements and dimensions. To simplify the view, the stress-relieving grooves in FIG. 7 are identified below with small letters. For example, the stress-relieving groove a presents a larger width in the middle than at its two ends. The facing stress-relieving groove b, on the other hand, presents in its middle a smaller width than at its ends. The stress-relieving grooves a, b face each other and present, for example, the same extent. However the extent can also be different. The characteristics, which are represented with regard to the stress-relieving grooves a, b, are, however, not limited to their mutual composition. Rather, the stress-relieving grooves a, b as well as the subsequently described geometries of stress-relieving grooves can in each case be mixed with each other in the arrangement with respect to a cylinder.

In the adjacent area of the further gas seal, four stress-relieving grooves c, d, e, f are arranged. While the stress-relieving grooves c, d have an arc shape, the stress-relieving grooves e, f present an at least approximately straight course. The stress-relieving grooves are in a point symmetrical arrangement according to this representation. As one can see in the representation, the result is a facing of the stress-relieving grooves b, e, where each is assigned to a single cylinder. These stress-relieving grooves run at least approximately transversely to a crankshaft that is not shown. In addition, a stress-relieving groove g can be arranged between the cylinders. The stress-relieving groove g is shown in a broken line representation and is located outside a sealing area of a cylinder. This stress-relieving groove g can be arranged, for example, in the cylinder block and/or in the cylinder head.

A stress-relieving groove h again has an interrupted course, but it forms here an approximately complete circle arranged inside the gas seal. The component stress-relieving grooves can here be approximately identical in each case. However, they also can present different widths and depths, and they can differ from each other with regard to the geometry of their stress-relieving groove.

A stress-relieving groove i is complementary to a facing stress-relieving groove j, with regard to an additional embodiment. The stress-relieving grooves i, j are preferably circular arcs, whose extent is smaller than the stress-relieving grooves k, l also arranged inside the gas seal. The stress-relieving groove k is here arranged opposite the stress-relieving groove course of the stress-relieving groove h. The result is a shifting of critical load spots toward thicker material.

In the following illustration of stress-relieving grooves m, n, an example is represented where the arrangement can also be offset with respect to a longitudinal axis corresponding to the crankshaft axis. This is a function of the resulting load profile in the cylinder head and also in the total assembly of the cylinder head and the cylinder block.

Below, a presentation is provided showing that, besides circular arc geometries, straight-line geometries can additionally characterize the shape of stress-relieving grooves. For example, one stress-relieving groove o faces the stress-relieving groove m. While the latter extends in the direction of the stress-relieving groove o, and thus assumes an angular position with respect to the not-shown crankshaft, the stress-relieving groove is transverse to the latter. By means of appropriate stress-relieving grooves, arranged transversely and also at an angle, the possibility thus exists to shift additional shifting possibilities of critical areas out of the gas seal area of the cylinder head, and thus potentially increase the useful life.

1. A multicylinder internal combustion engine (1) with a cylinder head (2) or individual cylinder heads and with a cylinder block (3), which are fixed to each other with a screw connection (4), where, between the cylinder head (2) and the cylinder block (3), one or more cylinder head seals (6) are arranged, characterized in that, between two cylinders, a separate stress-relieving groove (8) in the cylinder head (2) is associated with each one of the cylinders.

2. The multicylinder internal combustion engine (1) according to claim 1, characterized in that the cylinder head seal (6) presents at least one gas seal (7) in the area of each cylinder, where, in the cylinder head (2), within a diameter (10) determined by the gas seal (7), a stress-relieving groove (8) is arranged around a cylinder.

3. The multicylinder internal combustion engine (1) according to claim 2, characterized in that at least two stress-relieving grooves (8, 9), which run approximately parallel to each other, are arranged within the determined diameter (10).

4. The multicylinder internal combustion engine (1) according to claim 1, characterized in that in the cylinder block, a cylinder bushing is inserted and at least one of the stress-relieving grooves (8, 9, 14, 15, 16) is directly opposite a flange (13) of the cylinder bushing.

5. The multicylinder internal combustion engine (1) according to claim 1, characterized in that the cylinder head seal (6), with an at least approximately planar area, covers or partially covers the stress-relieving grooves (8, 9, 14, 15, 16).

6. The multicylinder internal combustion engine (1) according to claim 5, characterized in that the stress-relieving grooves (8, 9, 14, 15, 16) are at least substantially clear of the cylinder head seal (6).

7. The multicylinder internal combustion engine (1) according to claim 1, characterized in that at least one of the stress-relieving grooves (8, 9, 14, 15, 16) runs circularly around the cylinder.

8. The multicylinder internal combustion engine (1) according to claim 1, characterized in that the stress-relieving grooves (8, 9, 14, 15, 16) run at least partially transversely to a serial arrangement of the cylinders.

9. The multicylinder internal combustion engine (1) according to claim 1, characterized in that at least one stress-relieving groove (8, 9, 14, 15, 16) presents an interrupted course.

10. The multicylinder internal combustion engine (1) according to claim 1, characterized in that a base of the stress-relieving groove (8) presents different heights and depths.

11. The multicylinder internal combustion engine (1) according to claim 1, characterized in that at least the cylinder head (2) presents a light metal, and the cylinder head seal (6) is designed without a stopper.

12. The multicylinder internal combustion engine (1) according to claim 1, characterized in that the cylinder block (3) is made of a light metal.

13. A method for the determination of an optimized connection between a cylinder head (2) and a cylinder block (3) of a multicylinder internal combustion engine (1), which are to be screwed together, where the method presents the following steps:
entry of an FEM-capable representation of a start configuration with regard to at least the cylinder block (3), the cylinder head (2), and their screw connection,
entry of an FEM-capable representation of a start configuration with respect to a cylinder head seal (6), taking into account at least a gas seal or reinforcement seams, which in each case is or are arranged distributed around at least a first and a second adjacent cylinder bore (5),
entry of a start configuration of at least, in each case, a stress-relieving groove (8) associated with one of the first and the second cylinder bores (5), where the start configuration takes into account a position of the stress-relieving groove (8) between the gas seal and the associated cylinder bore (5), and
calculation of a thermomechanical fatigue behavior of at least the cylinder head (2) with optimization of at least one geometry parameter concerning the stress-relieving grooves (8, 9, 14, 15, 16) with a view to the thermomechanical fatigue behavior.

14. The method according to claim 13, characterized in that an optimization of the arrangement of the stress-relieving grooves (8, 9, 14, 15, 16) is computed.

15. The method according to claim 13, characterized in that an optimization of the number of stress-relieving grooves (8, 9, 14, 15, 16) is calculated.

16. The method according to claim 13, characterized in that, from a stored data library, a multitude of different cylinder head seal parameters is made available, and, in the context of the optimization between different cylinder head seals (6), an automated selection and its modification are carried out, until an optimized solution, in interaction with the fatigue behavior and the arrangement and geometry of the stress-relieving grooves (8, 9, 14, 15, 16), has been found.

17. The method according to claim 13, characterized in that numerous stoppers or reinforcement seams are associated in a distribution with, in each case, at least the first and the second cylinder bore, and taken into consideration in the optimization.
